(19) United States
(12) Patent Application Publication
(10) Pub. No.: US 2008/0106605 A1
(43) Pub. Date: May 8, 2008

(54) Secure Sensor Chip

(75) Inventors: Geert Jan Schrijen, Eindhoven (NL); Pim Theo Tuyls, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/577,355

(22) PCT Filed: Oct. 6, 2005
(86) PCT No.: PCT/IB05/53293

§ 371 Date: Apr. 17, 2007

(30) Foreign Application Priority Data
Oct. 18, 2004 (EP) 04105112.9

(51) Int. Cl. G06K 9/20; H04N 5/225

(52) U.S. Cl. 348/207.99; 382/312

(57) ABSTRACT

A method and device for providing a secure sensor chip (1) for recording digital information regarding at least one physical parameter, wherein the recording later can be verified with respect to its authenticity, whether the at least one physical parameter was indeed recorded by the specified chip (1) or not, wherein this is accomplished by providing the sensor chip (1) with a Controlled Physical Random Function (CPUF) in the form of a coating (5) and wherein both the sensor chip (1) and a micro controller (2) controlling all digital inputs (3) and outputs (4) of the sensor chip are both embedded in the CPUF coating (5).

The present invention refers to accomplishing a sensor chip for recording data or data sequences, which can later be checked with respect to the authenticity of the data, that is whether the later used data forms the original recorded data or not. As an example, in use of digital cameras and digital video cameras, wherein a picture or a video sequence is recorded, the authenticity of the data forming a picture or a video sequence later reproduced can be checked with respect to the data originally recorded.

Digital cameras have been on the market for quite some time. A digital camera is just one aspect of digital photography. Although you need the camera, in order to capture the image, there are many different tools and equipment that encompass the overall concept of digital photography. In fact, in order to develop a complete digital photography solution, all that is needed is a system of products that work together to help a user to take, store, manage, and display pictures, both on PCs and in familiar snapshot form. Thanks to advancements in technology this system is available today. It is essentially comprised of digital cameras, scanners, photo-quality printers, photo-editing software and digital photo albums.

For starters, a digital camera offers the user benefits, such as more flexibility in regards to the picture quality of the image. Much of the photo editing and enhancements are done after the picture has been taken. This feature is an advantage over a traditional film camera. With a traditional film camera, the user has to manually and properly adjust all the settings prior to taking the desired picture. A digital camera offers the ability to correct almost all aspects of a picture once it has been imported into a computer and the proper imaging software has been loaded.

Much of the fun in digital photography comes from imaging software used in manipulating the photograph that has been taken. Photo editing software allows an individual to add a little spice to a presentation or have fun distorting an image and such. With the use of photo-editing software special effects can be added to any image that has been imported into the computer via email, computer cable, scanner, diskette or Smart-Card. The possibilities are enormous. Many photo editing software packages exist on the market appealing to the most novice of users to those who are considered most savvy.

The most used image recording device in a digital camera is a charge-coupled device (CCD). The CCD is provided as an integrated circuit containing an array of linked, or coupled, capacitors. Under the control of an external circuit, each capacitor can transfer its electric charge to one or other of its neighbors.

CCDs containing grids of pixels are used in digital cameras, optical scanners and video cameras as light-sensing devices. They commonly respond to 70% of the incident light (meaning a quantum efficiency of about 70%,) making them more efficient than photographic film, which captures only about 2% of the incident light. An image is projected by a lens on the capacitor array, causing each capacitor to accumulate an electric charge proportional to the light intensity at that location. A one-dimensional array, used in line-scan cameras, captures a single slice of the image, while a two-dimensional array, used in video and still cameras, captures the whole image or a rectangular portion of it. Once the array has been exposed to the image, a control circuit causes each capacitor to transfer its contents to its neighbor. The last capacitor in the array dumps its charge into an amplifier that converts the charge into a voltage. By repeating this process, the control circuit converts the entire contents of the array to a varying voltage, which it samples, digitizes and stores in memory. Stored images can be transferred to a printer, storage device or video display.

Pictures or photographs are often used as proof or evidence in, for example, court cases. Also video footage from security cameras in public places is more and more used as evidence in crime investigations. Further, in many different situations people show images to prove that they have been somewhere or have seen something happen. In the cases as described it is of the utmost importance that one can rely on the integrity and authenticity of the presented images. In other words, is it possible to rely on an image, that it has not been tampered with and, that it is really the originally image recorded by the camera chip at the time of the first exposure that is displayed at a later occasion? Is there any possibility to be sure about that an image is not altered after it was created as there is, for example, nowadays provided on the market a lot of digital image editing software as discussed above?

A further example for use of the recording of digital images is to prove that a certain biometric was measured at a given place and at a given time. An example of a scenario may be in a system where users can get access to a building by placing their fingerprint or their iris image on a sensor. If, for some reason, you must get knowledge about which persons actually visited the building at a certain time, you want to get reliable information about who entered the building. It should not be possible for anyone (not even for a system operator) to create a false log of measured identification images.

Although, the example chosen here in relation to background art refers to camera chips, as an example, the discussions in the present document is relevant to all kind of prior art sensor chips registering physical parameters by means of a semiconductor chip/processor.

The conference paper from 18th Annual Computer Security Applications Conference, Dec. 9-13, 2002, Las Vegas, Controlled Physical Random Functions by Gassend, Clarke, Devadas, van Dijk discloses a theory where: “Controlled PUFs can be used to ensure that a piece of code only runs on a processor chip that has a specific identity defined by a PUF. In this way, pirated code would fail to run”. The disclosure of this document is hereby in its entirety included in the present application text by reference. The main ideas disclosed in said conference protocol are referenced in the following.

A Physical Random Function (PUF) is a random function that can only be evaluated with the help of a complex physical system. PUFs can be implemented in different ways (e.g. silicon, optical, acoustical, coating) and can be used in authenticated identification applications. Cryptographic keys can be derived from measurements of a PUF and these keys can for example be used for authentication purposes. A term: “Controlled Physical Random Functions (CPUFs)” defines a PUF that can only be accessed via a security algorithm that is physically bound to the PUF in an inseparable way within a security device. If a hacker tries to circumvent the security algorithm by getting physical access to the controller, this will lead to the destruction of the PUF and hence the destruction of the key material. Control is the fundamental idea that allows PUFs to go beyond simple authenticated identification applications.

PUFs and controlled PUFs enable a host of applications, including smartcard identification, certified execution and software licensing. In current smartcards cryptographic keys are usually stored in Read-Only Memory (ROM) or other non-volatile memory (e.g. EEPROM). It is possible for someone who is in possession of a smartcard to produce a clone of it, by extracting its digital key information through one of many well documented attacks. With a unique PUF on the smartcard that can be used to authenticate the chip, it is not required to store a cryptographic key in a non-volatile memory: the smartcard hardware is itself the secret key in case of silicon PUFs. In the case of coating PUFs, the coating around the IC forms the key. Such a key cannot be duplicated, so a person can lose control of it, retrieve it, and continue using it.

Certified execution produces a certificate which proves to the person requesting the computation that a specific computation was carried out on a specific processor chip, and that the computation produced a given result. This person can then rely on the trustworthiness of the chip manufacturer who can vouch that he produced the chip, instead of relying on the owner of the chip, who could make up the result without actually executing the computation. Certified execution is very useful in grid computing and other forms of distributed computation to protect against malicious volunteers. In fact, certified execution can enable a business model for anonymous computing, wherein computation can be sold by individuals and the customer can be ensured reliability of service, via the generation of certificates.

Controlled PUFs can also be used to ensure that a piece of code only runs on a processor chip that has a specific identity defined by a PUF. In this way, pirated code would fail to run.

It is possible to produce a so called digital PUF with classical cryptographic primitives provided a key can be kept secret. If an IC is equipped with a secret key k, and a pseudo-random hash function h, and tamper resistant technology is used to make k impossible to extract from the IC, then the function

x→h(k,x)

is a PUF. If control logic is embedded on the tamper resistant IC along with the PUF, then a CPUF has effectively been created.

However, this kind of CPUF is not very satisfactory. First, it requires high quality tamper-proofing. There are systems available to provide such tamper resistance. For example, IBM's PCI Cryptographic Coprocessor, encapsulates a 486-class processing subsystem within a tamper-sensing and tamper-responding environment where one can run security-sensitive processes. Smart cards also incorporate barriers to protect the hidden key(s), many of which have been broken. In general, however, effective tamper resistant packages are expensive and bulky. Secondly, the digital PUF is not manufacturer resistant. The PUF manufacturer is free to produce multiple ICs with the same secret key, or someone who manages to violate the IC's tamper resistant packaging and extract the secret key can easily produce a clone of the PUF.

Because of these two weaknesses, a digital PUF does not offer any security advantage over storing a key in digital form, and it is therefore better to use a conventional key storage system.

By exploiting statistical variations in the delays of devices (gates and wires) within the IC, a manufacturer resistant PUF can be created (a Silicon PUF). Manufactured IC's, from either the same lot or wafer have inherent delay variations. There are random variations in dies across a wafer, and from wafer to wafer due to, for instance, process temperature and pressure variations, during the various manufacturing steps. The magnitude of delay variation due to this random component can be 5% or more.

On-chip measurement of delays can be carried out with very high accuracy, and therefore the signal-to-noise ratio when delays of corresponding wires across two or more IC's are compared is quite high. The delays of the set of devices in a circuit is unique across multiple IC's implementing the same circuit with very high probability, if the set of devices is large. These delays correspond to an implicit hidden key, as opposed to the explicitly hidden key in a digital PUF. While environmental variations can cause changes in the delays of devices, relative measurement of delays, essentially using delay ratios, provides robustness against environmental variations, such as varying ambient temperature, and power supply variations.

The conference reference discusses how it can be assured that a certain piece of software can only run on a certain processor, which is important in the case of DRM (digital rights management) systems. Nothing is guaranteed about the result of running a software program. A specific processor can not give a proof of execution, which can be verified by anyone.

An alternative type of PUF is the “capacitive PUF” (or “coating PUF”). Coating PUFs consist of an array of capacitive sensors in the upper metal layer of a chip measuring the local (random) capacitances induced by the coating covering the chip. These capacitances are used to derive a unique identifier or key from the coating.

The materials system consists of a coating, which is applied directly on top of an IC, and which has inhomogeneous (di)electric properties. Capacitive sensors are present on the IC, embedded in the upper metal layer. These sensors capacitively sense the local (di)electric properties of the coating. Multiple keys (i.e. responses to challenges) can be read out by covering the IC with a multitude of sensor structures, and selectively addressing one or a few of them. Additional challenge-response pairs might be created by measuring at different frequencies, or with different voltage modulation amplitudes.

An important advantage of this type of PUFs is the relative simplicity of the material and measuring system. The measurement is done at little additional cost, as no external equipment is needed, but the sensor and processing of the data can simply be integrated in the IC itself. Usually, the coverage of the upper metal layer contains very few functional lines (mostly tiling), so this can be replaced by coating sensing structures at no extra cost. An extra advantage is that it is impossible to directly access (or read out) the measurement system, without destroying the PUF itself.

One object of the invention is to provide a device and a method, wherein the output when running a certain program on a particular sensor chip is some digital data and wherein the output contains an accompanying proof, which guarantees that this data is really the result of a recording with that particular sensor chip! Hereby it is assured that a recording program has been executed and that certain data is a result of the recording on the identified particular sensor chip. Just to take a controlled PUF and simply connect a sensor chip to it (via wires or a circuit board) is not enough to ensure complete protection and safety.

According to one aspect of the present invention there is disclosed a method as specified in the independent method claim.

According to a further aspect of the invention there is disclosed a device as specified in the independent device claim.

An advantage arrived at by the aspects of the invention is that any type of sensor using a chip can be made secure. The solution is that by combining a sensor chip with a PUF, preferably a Coating PUF, and by using “e-proofs” you create a secure sensor in the sense that the data measured/registered by the sensor chip used in said sensor can be proven to be authentic. So together with the measurement data a cryptographically secure proof that this measurement data was indeed measured by the specific sensor chip is obtained.

The term sensor chip includes all kinds of chips used for recording a physical parameter, whereby the term chip includes equivalents such as a processor or an ASIC. The sensor chip can be designed for:

detecting light by use of light detecting elements such as for image recording in cameras (CCD or CMOS chips), wherein the term light includes at least visible light, infrared light and ultraviolet light,

detecting temperature by use of temperature sensing elements,

detecting pressure by use of pressure sensing elements,

detecting sound by use of sound recording elements,

detecting radio and radar waves

detection of acceleration, speed, movement, location (e.g. GPS), humidity

The sensor can further include a sensor element from the group of: opto-electronic sensors, laser-sensors, sensors for radioactive radiation, chemical sensors (sensing chemical elements or compounds).

The Coating CPUF around the sensor chip has the property that it is easy to evaluate, but extremely difficult to clone or to characterize. Therefore the coating layer can be used to uniquely identify the combined sensor chip and the CPUF. All digital inputs and outputs of the sensor chip are controlled by the microprocessor (the CPUF controller) that has access to the PUF. Only pre-defined protocols can be executed on this micro processor. These protocols are designed in such a way that the chip can only be used in a secure way (without leaking secret information about the PUF layer).

One of the protocols will let the sensor chip to record the desired data and to provide it to the output together with a proof of the execution as described below in the embodiments. This proof makes use of the unique (uncloneable) properties of the specific CPUF in which the sensor chip is embedded. An adversary cannot abuse the chip to create false proofs of execution, since this would require an execution of instructions outside the pre-defined protocols, which can only be accomplished by getting physical access to the sensor chip. Since the chip is coated with the CPUF, invading the chip will change or destroy the properties of the CPUF and lead to invalid proofs of executions.

The proof of execution proves to any verifier that a certain data recording was performed by the specific “secure sensor chip”, which is identified by the properties of its PUF. An additional identity value (a unique number) can of course be added to ease identification.

One very important advantage by use of the disclosure is that the sensor chip as well as the controller are arranged inside the CPUF coating such that the output data of the sensor can directly be processed by the controller and no hacker can influence the communication between sensor chip and controller. If a hacker wants to invade the chip and get access to information or code inherent in the sensor chip and/or the also embedded controller he must get physical access to the chip and he must invade the PUF coating which will destroy the key material and hence no valid proof can any more be generated from the chip.

The sensor chip as well as the controller are located inside the CPUF coating such that the output data of the sensor chip can directly be processed by the controller, whereby no hacker can influence the communication between sensor chip and controller. The prior art reference above discusses that it can be assured that a certain piece of software can only run on a certain processor. It does not guarantee anything about the result of running a software program. The present invention discloses that a sensor can really give a proof of execution which can be verified by anyone. So the output of running a certain program (here: a measurement using the sensor) is some digital data and the accompanying proof guarantees that this data is really the result of that measurement with that particular sensor. By this it can be assured that the measurement program has been executed (and that certain data is the result) on the identified sensorchip/processor. This proof can be verified by anyone (e.g. an independent party) that also has access to the sensor.

These and other aspects of the invention will be apparent from and elucidated with reference to the embodiment(s) described hereinafter.

Application of the present invention is especially useful in all kind of devices where there is a need of verifying that data recorded by use of a specific sensor chip has indeed been recorded by that very sensor chip, for example in security cameras (e.g. used for supervising purposes).

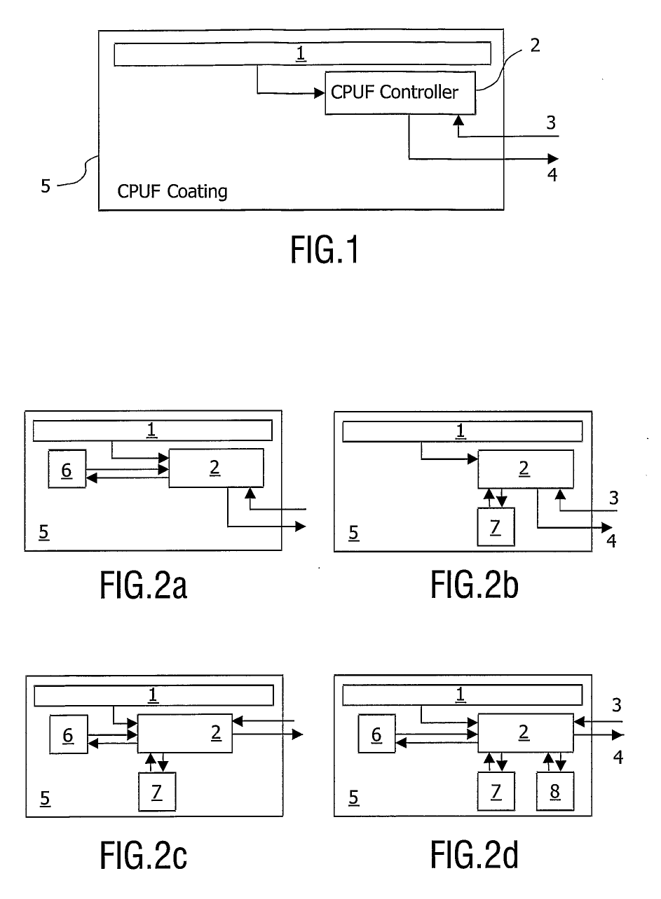

FIG. 1 schematically shows a sensor chip embedded according to an aspect of the invention

FIG. 2 schematically shows different embodiments of the sensor including modules for time and position recordings as well as a memory for logging time and position data.

A number of embodiments for performing the method according to the invention will be described in the following supported by the enclosed drawings.

One embodiment of the invention is implemented by coating the chip and the micro controller (the micro controller is in this document referred to as simply the controller) with a Physical Random Function (PUF) layer, preferably in the form of a coating PUF. A schematic view of this embodiment may be seen in FIG. 1, wherein a sensor chip according to one embodiment of the invention is shown. In the Figure the sensor chip is referred to by the numeral 1. The sensor chip is controlled by the micro controller 2 (called CPUF controller) which is connected to the outside world by means of an input line 3 and an output line 4. These input and output lines are the only connections to the outside world. Both the sensor chip and the micro controller 2 are embedded in a CPUF coating 5. In the depicted example, the sensor chip 1 is supposed to be represented by a digital camera chip, for example a CCD chip.

In FIGS. 2 a-d there are shown examples of modules included in the CPUF coating. The first one, 2a, shows a clock module 6 integrated with the sensor chip 1 and connected to the CPUF controller 2, whereby the time for a recorded parameter can be logged securely. The second one, 2b, shows a positioning module 7 integrated with the sensor chip 1 and connected to the CPUF controller 2, whereby the place for a recorded parameter can be logged securely. FIG. 2c shows a chip where both a clock module 6 and a positioning module 7 are integrated with the CPUF controller 2, whereby both the time and the place of a parameter event can be logged securely. Further, an additional memory 8 may be embedded in the CPUF coating for logging time and position of the time for a parameter recording and/or for use as registering the time and/or position when there has been events of tampering with the sensor chip 1. Other combinations are of course possible, such as for example extending the embodiment according to FIG. 2a or FIG. 2b to include a logging memory 8.

A PUF is a function that is easy to evaluate but hard to characterize. Examples are optical one way functions silicon PUFs (discussed previously) and coating PUFs. They have the advantage with respect to digital PUFs (one way functions) that they are non-cloneable. This makes them very well suited for authentication and identification purposes. Silicon PUFs exploit the statistical variations in the delays of gates and the wires within the IC integrated with the PUF.

An important mechanism in cryptographic protocols is a challenge-response mechanism of which an example goes as follows: a verifier V wants to verify if a prover P knows a piece of secret information thereby, for example proving its identity. Therefore, V sends a challenge c to P and P uses c to formulate an answer based on c and a unique piece of knowledge known only to P. V checks the answer given by P and decides if he accepts it or not. Common implementations are based on public key cryptography: P issues a public key PK and keeps the corresponding key SK secret. V chooses a random number r, encrypts it using PK and sends it to P. The challenge for P is to come up with the random user value r. Clearly, if P knows SK, he can give the proper answer to V proving the fact that he knows SK.

A disadvantage of the digital approach in the previous section is that an attacker can open the prover device P, read out SK and use this information in another device thus successfully impersonating P. The reason why this is possible is that the secret information stored in P is cloneable. Moreover, the silicon PUF proposed in the conference paper identified in the prior art above seems to be sensitive to environmental changes such as temperatures, capacitive fields and power supply variations. This can cause them to make irreproducible events. In that case they can not be reliably used for authentication and identification purposes in all circumstances. Therefore, it is disclosed, according to one aspect of this invention, to base the PUF on some unique properties (less sensitive to external variations) of an (even in the factory) uncloneable device, more specifically, to base it on a special coating on top of an IC (chip, processor). Such a coating can be used to detect tampering of device. The idea is that the presence of the coating is verified by sensing that the properties are unique for the device because of inherent randomness in the production process of the layer, whereby it is possible to derive from it a unique device identifier. The dielectric property can be determined by use of some kind of capacitance (or impedance) measurement. In most practical cases the capacitance will depend on the frequency in a way unique for each separate device. This effect can be used as an advantage in generating a response to a challenge.

In order to identify itself, a device will receive a challenge c from a verifier. This can for example be achieved by generating a response as follows.

r=h₂(c,PUF(h₁(c))) (1)

where c stands for challenge, r for response and the hash functions h₂ and h₁ are linked in a physically inseparable way to the PUF. The device containing the coating will have a number of sensors capable of measuring a local physical property of the coating (e.g. the capacitance, the impedance, etc.). A part of the challenge c₁ is used to determine which subgroup of sensors, that is used. As an illustration one could think of an array of n sensors. The c₁ part of the challenge prescribes which of the sensors that could be used. Alternatively, c₁ indicates not one but a number of sensors (i.e. capacitors). These can then be connected in parallel for a measurement.

In a second step to generate a response r to challenge c, a measurement must be done using the subset of sensors indicated by the part c₁ of the challenge. One possibility is to use a part c₂ of the challenge c to parameterize the measurement. The outcome of the measurement or a hash thereof (eq. 1) will be the response r of the device to the challenge c.

As a summary, there is claimed a PUF implemented as an IC including a sensor chip (can also be in the form of a processor, as well as an ASIC) in combination with at least a micro controller and in some embodiments further including a clock module, a positioning system module and all together having a coating with locally varying physical properties (e.g. capacitance, resistance, etc.) that are measured on the chip using parameterized measurement. The parameters of the measurement are derived from the challenge and the response is derived from the outcome of the measurement.

In a CPUF a security program is used under control of the security algorithm, linked to the PUF, such that the PUF can only be accessed via two primitive functions GetSecret(.) and GetResponse(.) from the security program. GetSecret(.) ensures that the input to the PUF depends on a representation of the security program from which the primitive functions are executed. GetResponse(.) ensures that the output of the PUF depends on a representation of the security program from which the primitive functions are executed. Because of this dependence, the input to the PUF and output of the PUF will be different if these primitive functions are executed from within a different security program. Furthermore, these primitive functions ensure that the generation of new challenge-response pairs can be regulated and secure as is also described in prior art.

Certified execution, also described in prior art, uses the GetSecret(.) primitive on a challenge for which the user can compute the output based on a secret PUF challenge-response pair that is known only to the user. In this way the output can be used towards the user to prove that he executed an algorithm on the specific processor chip with the PUF algorithm.

However, the user can not use the output to prove to a third party that the program was actively executed on a specific processor, because the user could have produced the result himself using his challenge-response pair. In, for example, electronic transaction systems, it is however often desirable to be able to actually prove to a third party that a program (such as program to pay a fee for viewing a program) has been executed on a specific processor.

It is therefore used in the present invention a method that enables the generation of proof results, that can be used as a proof of execution for a specific computation on a specific processor, called e-proof, as a certificate that is verifiable by any third party. This kind of e-proof will be delivered by the output of the micro controller to the outside world of the sensor chip together with the delivery of the data recorded by the sensor chip.

This object is realized by a method (prior art) to prove authenticity of execution of program instructions, comprising:

a step of executing program instructions under control of a security program on a security device (e.g. a sensor chip in the present invention) comprising a random function (e.g. a PUF), the random function being accessible only from the security program through a controlled interface, the controlled interface comprising at least one primitive function accessing the random function that returns output that depends on at least part of a representation of at least those parts of the security program that call the primitive function,

a step of, using the random function, computing proof results during execution of the security program operating in a first mode by accessing the random function through the controlled interface and

a step of, using the random function, verifying the proof results during execution of the same security program operating in a second mode by accessing the random function through the controlled interface.

The security program can be run in different operation modes, either in the same or different execution runs. By having at least two operation modes in the same program, the security program can advantageously use the random function in different program executions. Because the primitive function accessing the random function depends also on the representation of at least part of the security program, which is the same security program operating in different modes, access to the random function is guaranteed for the security program in these different modes, and any other security program can not access the random function in a way that compromises the security offered by the random function. The “multi-mode” program is therefore an advantageous concept as the functionality in the other modes is already clearly defined and limited during the first time the security program is executed.

By making the output depending on a representation of the security program, it is (almost) guaranteed that any other security program that is run on the security device obtains different results for the same input through the controlled interface. Any other security program, for example designed by a hacker, to obtain information to generate illicit proof results obtains only useless results through the controlled interface because the results depend on the security program representation, which is different for the original security program and the security program used by a hacker.

The representation of the security program could be a hash or other signature, or a part thereof. Normally, the representation of the security program covers the complete security program, but in special cases (for example where the security program contains large parts that don't concern the random function) it might be advantageous to limit the representation to those parts of the security program that handle the calling and handling of the input and output of the primitive function.

During execution of the security program, a key can be derived using a primitive function of which the output depends also on a representation of the security program. This key can be used to encrypt (part of) the proof results. Any result that is encrypted by this key is useless except in subsequent executions of the same security program, either in the same or in a different mode.

The security program is typically provided by the user of the security device. This could also be a different subsystem or another system.

To allow quick retrieval of a specific security program for later use, the program code could therefore be stored, or a hash code thereof, for subsequent execution of the security program in the same or in a different mode, optionally together with information about permission who is allowed subsequent execution.

Using this method CPUFs can be used to produce as proof results a proof of execution, called e-proof, which is a certificate verifiable by any third party (who has access to the sensor device). This kind of e-proof can, according to one aspect of the present invention, be delivered from the micro controller embedded inside the CPUF to the outside world together with the parameters recorded by means of the sensor chip.

Furthermore, the CCD chip and the micro controller should be extended with some extra processing capabilities in order to give it the functionality of a controlled PUF, a CPUF.

The positioning (location) system for use in the claimed method and device is one from the group of: a satellite positioning system (GPS), a positioning system using positioning satellites in combination with ground-based positioning transmitters, a positioning system using only ground-based positioning transmitters.

Additional memory, in which events are logged, can be added to the sensor chip/CPUF controller. For example, sequential data from the clock module and the GPS module can be registered on this log. Irregularities in the registered data sequence could then be used to prove tampering of time or location data (an adversary could try to create false GPS signals or try to reset the internal clock by applying electromagnetic fields or shocks). Reading out the log can only be done via a prescribed protocol in the CPUF controller.

Although the present invention has been described in connection with specific embodiments, it is not intended to be limited to the specific form set forth herein. Rather, the scope of the present invention is limited only by the accompanying claims. In the claims the terms comprising and including do not exclude the presence of other elements or steps. Furthermore, although individually listed a plurality of means, elements or method steps may be implemented by e.g. a single unit or processor. Additionally, although individual features may be included in different claims, these may possibly be advantageously combined and the inclusion in different claims does not imply that a combination of features are not feasible and/or advantageous. In addition, singular references do not exclude a plurality. Thus references to “a”, “an”, “first”, “second” etc. do not preclude a plurality. Reference signs in the claims are provided merely as clarifying examples and shall not be construed as limiting the scope of the claims in any way.

1. A method for recording digital information with a sensor registering data regarding at least one physical parameter, comprising the steps of:
providing said sensor with a sensor chip (1),
providing said chip (1) with a Controlled Physical Random Function, CPUF, formed by means of a CPUF coating (5),
controlling all inputs (3) and all outputs (4) of the sensor chip (1) by means of a CPUF controller (2) and
embedding both the sensor chip (1) and the CPUF controller (2) in said CPUF coating (5).

2. The method according to claim 1, further comprising the step of providing together with an output of the recorded data an e-proof verifying that the outputted data is recorded on said specific sensor chip (1).

3. The method according to claim 2, further comprising the step of recording light by means of said sensor chip (1).

4. The method according to claim 3, further comprising the step of arranging said light recording to be performed by means of a CCD camera chip or a CMOS camera chip.

5. The method according to claim 4, further comprising the step of providing a digital camera or a digital video camera with said sensor.

6. The method according to claim 4, further comprising the step of mapping by means of said sensor chip (1) the iris pattern of a human.

7. The method according to claim 4, further comprising the step of mapping by means of said sensor chip (1) the fingerprint pattern of a human.

8. The method according to claim 2, further comprising the step of recording sound by means of said sensor chip (2).

9. The method according to claim 8, further comprising the step of mapping by means of said sensor chip (1) the voice pattern of a human

10. A sensor for recording digital information regarding at least one physical parameter, comprising a sensor chip (1), characterized in that
the sensor chip (1) is provided with a controlled PUF (CPUF) in the form of a CPUF coating (5),
all digital inputs (3) and outputs (4) of the sensor chip (1) are controlled by a micro controller, a CPUF controller (2) and
both the sensor chip (1) and the CPUF controller (2) are embedded in said CPUF coating (5).

11. The sensor according to claim 10, wherein said chip (1) is a light detecting chip consisting of light detecting elements.

12. The sensor according to claim 11, wherein said chip (1) consists of an array of light detecting elements.

13. The sensor according to claim 12, wherein said chip (1) is a Charged Coupled Device chip (CCD).

14. The sensor according to claim 12, wherein said chip (1) is a CMOS camera chip.

15. The sensor according to claim 11, wherein said chip (1) is designed for mapping an Iris pattern of a human.

16. The sensor according to claim 11, wherein said chip (1) is designed for mapping a fingerprint pattern of a human.

17. The sensor according to claim 10, wherein said chip (1) is designed for registrating a voice pattern of a human.

18. The sensor according to claim 10, wherein a clock module (6) is embedded in the chip (1), whereby the output from said CPUF controller (2) includes a registration of the time of said recording.

19. The sensor according to claim 10, wherein a positioning system module (7) is embedded in the chip (1), whereby the output from said CPUF controller (2) includes a registration of the place for said recording.

20. The sensor according to claim 10, wherein said chip (1) is provided with at least an element being a sensor for any one of the physical parameters from the group of: light, temperature, pressure, sound, acceleration, speed, movement, location, humidity, electromagnetic energy.

21. The sensor according to claim 10, wherein said chip (1) includes a sensor element from the group of: opto-electronic sensors, laser-sensors, sensors for radioactive radiation, chemical sensors (sensing chemical elements or compounds).

22. The sensor according to claim 18, wherein said chip (1) is provided with a memory (8) for logging events registered by said module.

23. The sensor according to claim 10, wherein said CPUF controller (2) is integrated into said sensor chip (1).

24. The sensor according to claim 10, wherein said CPUF controller (2) is designed to output data including an e-proof verifying that the outputted data is recorded on said specific sensor chip (1).

25. A digital camera provided with the sensor according to claim 1.
